(19) United States
(12) Patent Application Publication
(10) Pub. No.: US 2005/0085215 A1
(43) Pub. Date: Apr. 21, 2005

(54) Method and related apparatus for emergency calling in a touch screen mobile phone from a touch screen and keypad lock active state

(75) Inventors: Petri Kokko, Oulu (FI); Markku Autio, Oulu (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/692,022

(22) Filed: Oct. 21, 2003

(51) Int. Cl. H04M 11/04

(52) U.S. Cl. 455/404.1; 455/556.2

(57) ABSTRACT

A method and related apparatus for emergency calling in a touch screen mobile phone having a touch screen lock in an active state responds to a long press on the touch screen surface or a designated key and enables the mobile phone dialer to dial the emergency call number to establish an emergency call. A sequence of operational steps may be provided by instruction message which in response thereto deactivates the touch screen lock while establishing the emergency call.

### TECHNICAL FIELD

The present invention relates generally to touch screen display mobile telephones such as cellular telephones having a touch screen lock and deals more particularly with emergency calling in a touch screen mobile phone from a touch screen lock active state.

### BACKGROUND OF THE INVENTION

Touch screen displays are well known in the art for showing graphics and text in mobile telephones such as cellular phones and to provide a user interface mechanism to enter commands to control the mobile phone or to perform various other phone and non-phone functions to carry out the operation of the device. The touch screen may be of any suitable type to carry out the intended function, for example, resistive touch screen such as film-on-glass or other such touch screen technology now known or future developed. The touch screens, which may also have color display functionalities, are generally designed to operate and respond to a finger touch or press, a stylus tap or other contact movement on the touch screen surface. Touch screens may be used in addition to, in combination with or in place of physical keys traditionally used in a mobile phone, for example, a cellular phone to carry out the phone functions and features. Touching or tapping a specific point on the touch screen display will activate a virtual button, feature or function found or shown that location on the touch screen display. Typical phone and non-phone features which may be operated by touching or tapping the touch screen display include entering a telephone number, for example, by tapping or touching virtual keys of a virtual keyboard shown on the display, making a call or ending a call, bringing up, adding to or editing and navigating through an address book, and other functions such as messaging, wireless connection to the global computer network and other phone and non-phone functions now known or future developed.

Cellular telephones may also be used with touch screen displays. The virtual keys on touch screen are finger operated to control the phone and to select and carry out various desired phone functions, for example, increasing listening volume, starting or ending a call, accessing speed dialing, or other various phone features. One problem generally associated with the use of touch screen displays in mobile telephones, in which call progression or selecting and activating phone features by touching or pressing the touch screen display at specific locations is the susceptibility to accidental or unintentional activation or deactivation of phone functions such as, for example, accidentally ending a call during the course of the ongoing call due to the user touching the display screen when the phone is held in the talking position or is carried when used with a headset. One solution to the aforementioned problems of accidental or unintentional phone operation is to activate and deactivate the touch screen and keys of the cellular phone to prevent accidental or unintentional operation during an ongoing call. Such a solution to solve the aforementioned problems is disclosed in a co-pending patent application assigned to the same assignee as the present invention, entitled “Method and Apparatus for Locking a Mobile Telephone Touch Screen” (application will be identified by serial number and filing date currently Attorney Docket No. 944-005.018). The application discloses a touch screen lock that has an active mode to lock the touch screen from operation to prevent accidental or unintentional operation and a deactivated mode to make the touch screen active for operation to allow phone and non-phone features operation during an ongoing call.

Although the touch screen lock provides the necessary locking and unlocking of the touch screen of the cellular telephone, the making of an emergency call from such a locked state is somewhat cumbersome in that a number of operational steps are required to activate the touch screen to deactivate the touch screen lock to permit the dialing of an emergency call number.

It is an object of the present invention therefore to solve the aforementioned problems and disadvantages of a touch screen mobile telephone having a touch screen lock and provide an apparatus and method for emergency calling in a touch screen mobile phone from a touch screen lock active state.

### SUMMARY OF THE INVENTION

In accordance with a first embodiment of the invention, a method for emergency calling in a touch screen mobile phone such as a cellular phone having a touch screen lock is presented and is characterized by the steps of touching or pressing the surface of the touch screen; providing a message on the touch screen display indicating that only emergency calls are allowed; providing a mobile phone dialer on the touch screen display; entering an emergency call number into the mobile phone dialer; pressing the call key to dial the emergency call number; and establishing the emergency call connection.

In accordance with another aspect of the invention, the method is characterized by the steps of clearing an entry into the mobile phone; resetting the timer in response to clearing an entry into the mobile phone dialer and conditioning the mobile phone dialer for a further entry in response to resetting the timer.

In accordance with a further aspect of the invention, the method is characterized in that the entry is an alphanumeric entry.

In accordance with a yet further aspect of the invention, the method is characterized in that the entry is an event entry.

In a still further aspect of the invention, the method is further characterized by the step of locking the touch screen from operation in the absence of operating any key on the keypad within a third predetermined time interval duration and activating the touch screen lock in response thereto.

In another embodiment of the invention, the method is characterized by the steps of pressing the END call key for a first time duration interval and activating the mobile phone dialer on the touch screen display in response to the END call key being pressed for a time duration interval equal to or greater than a first predetermined time duration interval; dialing the emergency call number, and establishing the emergency call connection.

In a further embodiment of the invention, apparatus for emergency calling from a touch screen locked state in a touch screen display mobile phone having a touch screen lock is presented. The apparatus includes a mobile phone dialer, means for detecting contact with the surface of the touch screen display, and in response to such contact providing an “ONLY EMEGENCY CALLS ALLOWED” message on the touch screen display, means for entering an emergency call number into the mobile phone dialer, and means for activating the mobile phone dialer to dial the emergency call number.

In a further aspect of the invention, the apparatus further includes means for establishing the emergency call connection.

In another aspect of the invention, the mobile phone dialer includes means responsive to the operation of a first predetermined key to dial the emergency call number.

In a further aspect of the invention the first predetermined key is the CALL key.

In a yet further aspect of the invention the apparatus a timer, means for clearing an entry into the mobile phone dialer; means for resetting the timer in response to the clearing of an entry made into the mobile phone dialer wherein the mobile phone dialer is conditioned for a further entry in response to the timer being reset. The cleared entry may be an alphanumeric entry or an event entry.

In a still further aspect of the invention, the touch screen is locked from operation in response to the absence of detection of touch screen surface contact within a third predetermined time interval duration.

In a yet another aspect of the invention, the mobile phone dialer is responsive to a second predetermined key being operated for a time duration interval equal to or greater than a first predetermined time duration interval.

In a still further aspect, the second predetermined key is the END key.

### BRIEF DESCRIPTION OF THE DRAWINGS

These and other objects and features of the present invention will become readily apparent from the following description taken in conjunction with the preferred embodiments thereof with reference to the accompanying drawings in which:

FIG. 1 is a schematic perspective view of a virtual keypad touch screen mobile phone embodying the present invention;

FIG. 2 is a flow chart showing one sequence of the method of the present invention for making an emergency call from a touch screen and keypad lock active state;

FIG. 3 is a schematic functional block diagram showing the major functional components of the touch screen mobile phone embodying the present invention.

### WRITTEN DESCRIPTION OF PREFERRED EMBODIMENTS

Turning now to the drawings considering the invention in further detail, a schematic perspective view of a touch screen mobile phone with a touch screen lock embodying the present invention is illustrated therein and generally designated 10. The touch screen mobile phone 10 includes a touch sensitive display screen generally designated 20 and which has a surface 22 appearing the window area generally designated 24 of the mobile phone case 26. The mobile phone 10 may also include control keys 30, 32 also referred to as soft keys whose functionality changes in dependence on the mode on the mobile phone. The functionality of the soft keys 30, 32 is controlled by a controller and is displayed in separate areas in the display 20 wherein the areas are adjacent to the two keys 30, 32 although other locations are likewise usable. The soft keys 30, 32 are preferably used to select and execute instructions entered by the other keys or suggested by the controller and displayed in the display 20. Likewise, the side keys 12, 14, 16 may be used in a similar manner as the soft keys 30, 32 to select and execute instructions. The touch screen mobile phone 10 also includes a touch screen lock which in an active state prevents operation of the touch screen to avoid accidental, inadvertent or unintentional operation of phone features or functions.

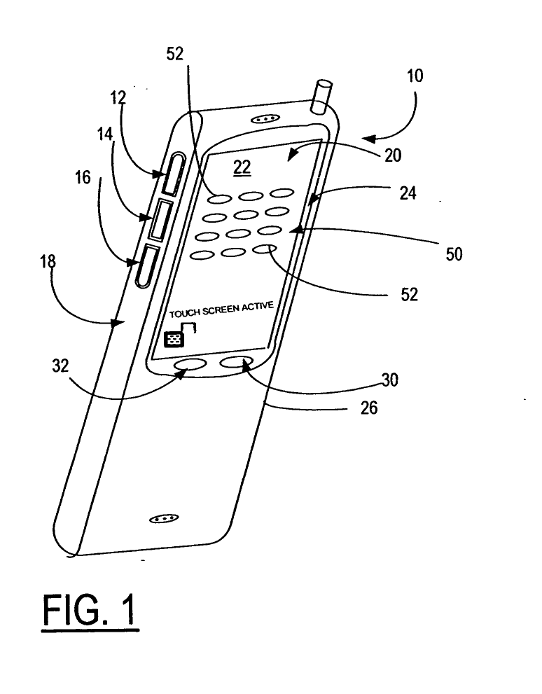

Still referring to the mobile phone 10 illustrated in FIG. 1, the keypad is a virtual keypad 50 and operates by touching the corresponding virtual keys 52, 52 shown on the display screen 20. The virtual keypad 50 appears on the display screen 20 as required interspersed with the appropriate messages which may be shown on the display screen during the sequence of the operational steps to deactivate the touch screen lock. The keypad 50 also functions in connection with the operation of the mobile phone dialer for dialing the emergency call number. The specific details describing the inter-exchange of graphics and text on the display screen are not necessary for an understanding of the present invention. The touch screen mobile phone 10 may also include a physical keypad and physical keys which operate in a conventional well known manner.

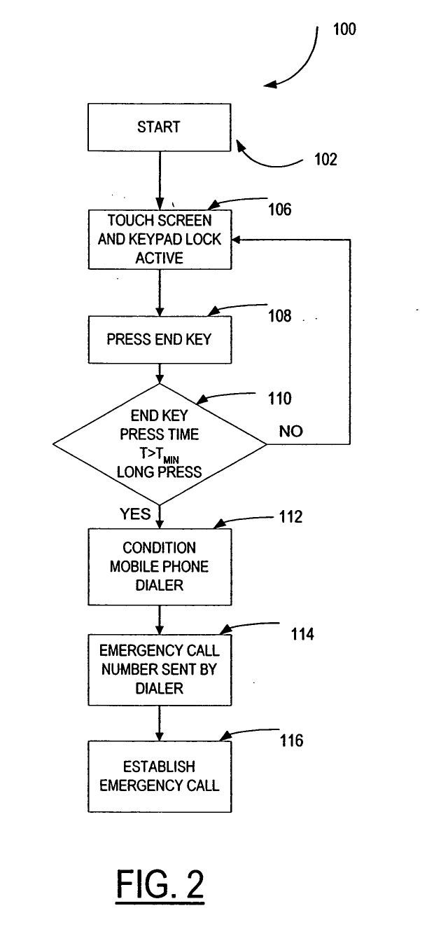

Turning now to FIG. 2, a flow chart generally designated 100 shows one sequence of the method of the present invention for making an emergency call from a touch screen lock active state in a touch screen mobile telephone and begins generally with the start step 102. The touch screen lock is in an active state as indicated in step 106. In the method illustrated in FIG. 2, pressing the END key in step 108 for a predetermined time deactivates the touch screen lock. The END key may be a physical key on the keypad or a virtual button on the screen display of the mobile telephone. A timer determines if the END key is pressed for a sufficient time in step 110 wherein the time the END key is pressed must be equal to or greater than a minimum time to qualify as a “long press”. If it is determined that the time the END key is pressed is less than the minimum time, the touch screen lock remains in an active state as indicated in step 106. If it is determined in step 110 that the END key is pressed for a time equal to or greater than the minimum time to qualify for a “long press” the method then conditions the mobile phone dialer in the step 112 to place the emergency call and the emergency call number is sent by the dialer in step 114 to established the emergency call in step 116.

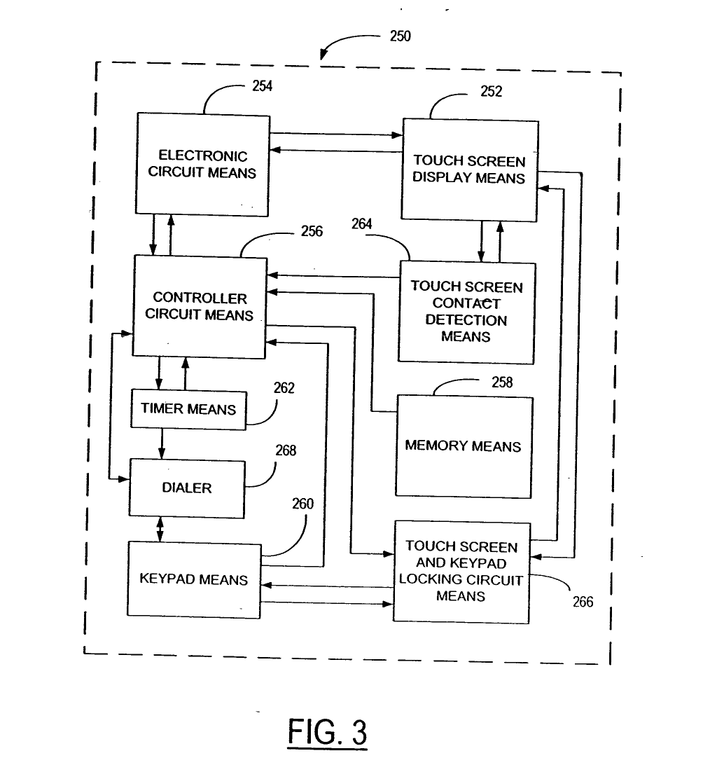

Referring to FIG. 3, a schematic functional block diagram generally designated 250 is illustrated therein showing the major functional components of the touch screen mobile phone with a touch screen lock embodying the present invention and includes a suitable touch screen display means 252 well know to those skilled in the art. Electronic circuit means 254 appropriate for carrying out the functions of the mobile phone is provided. A controller circuit means or CPU 256 which may be part of the electronic circuit means 254 but for purposes of explanation is shown as a separate functional element in FIG. 3 cooperates with an instruction set contained within a memory means 258 and a keypad means 260 for input and function selection or in cooperation with the touch screen contact detection means 264 for input and function selection. Timer means 262 also cooperates with the controller circuit means 256 and the dialer 268 to carry out various timing functions in accordance with the instructions retrieved from the memory means 258 via the controller circuit means 256. A touch screen locking circuit means 266 is responsive to the controller circuit means 256 for activating and deactivating the keypad means 260 and the touch screen display means 252. The keypad means 260 contemplates all the keys found on the mobile phone including virtual keys shown on the display of the touch screen display means. The operational interconnection of the major functional elements of the mobile phone are well known to those skilled in the art and may be of any appropriate design to carry out the intended functions.

A method for emergency calling in a touch screen mobile phone having a touch screen and keypad lock has been described above in several preferred embodiments along with a touch screen mobile phone embodying the method. Numerous changes and modifications may be made by those skilled in the art without departing from the spirit and scope of the invention and therefore the invention has been disclosed by way of illustration rather than limitation.

1. A method for emergency calling in a touch screen mobile phone from a touch screen locked state characterized by the steps of:
pressing the surface of the touch screen;
providing a message on the touch screen display indicating that only emergency calls are allowed;
providing a mobile phone dialer on the touch screen;
entering an emergency call number into the mobile phone dialer;
pressing the call key to dial the emergency call number, and
establishing the emergency call connection.

2. The method for emergency calling in a touch screen mobile phone as defined in claim 1 further characterized by the steps of:
clearing an entry into the mobile phone;
resetting the timer in response to clearing an entry into the mobile phone dialer, and
conditioning the mobile phone dialer for a further entry in response to resetting the timer.

3. The method for emergency calling in a touch screen mobile phone as defined in claim 2 further characterized in that the entry is an alphanumeric entry.

4. The method for emergency calling in a touch screen mobile phone as defined in claim 2 further characterized in that the entry is an event entry.

5. The method for emergency calling in a touch screen mobile phone as defined in claim 1 further characterized by the step of locking the touch screen from operation in the absence of operating any key on the keypad within a third predetermined time interval duration and activating the touch screen lock.

6. A method for emergency calling in a touch screen mobile phone from a touch screen locked state characterized by the steps of:
pressing the END call key for a first time duration interval;
activating the mobile phone dialer on the touch screen display in response to the END call key being pressed for a time duration interval equal to or greater than a first predetermined time duration interval;
dialing the emergency call number, and
establishing the emergency call connection.

7. Apparatus for emergency calling from a touch screen locked state in a touch screen display mobile phone having a touch screen lock, characterized by:
means defining a mobile phone dialer;
means for detecting contact with the surface of the touch screen display;
means responsive to touch screen surface contact detection for providing an “ONLY EMEGENCY CALLS ALLOWED” message on the touch screen display;
means for entering an emergency call number into said mobile phone dialer, and
means for activating said mobile phone dialer to dial the emergency call number.

8. The apparatus for emergency calling as defined in claim 7 further characterized by means for establishing the emergency call connection.

9. The apparatus for emergency calling as defined in claim 7 wherein said means for activating said mobile phone dialer is further characterized in that said mobile phone dialer includes means responsive to the operation of a first predetermined key to dial the emergency call number.

10. The apparatus for emergency calling as defined in claim 9 further characterized in that said first predetermined key is the CALL key.

11. The apparatus for emergency calling as defined in claim 7 further characterized by:
means defining a timer;
means for clearing an entry into said mobile phone dialer;
means for resetting said timer in response to said means clearing an entry into said mobile phone dialer, and
means for conditioning said mobile phone dialer for a further entry in response to said timer being reset.

12. The apparatus for emergency calling as defined in claim 11 further characterized by an alphanumeric entry.

13. The apparatus for emergency calling as defined in claim 11 further characterized by an event entry.

14. The apparatus for emergency calling as defined in claim 7 further characterized in that the touch screen is locked from operation in response to the absence of detection of touch screen surface contact within a third predetermined time interval duration.

15. The apparatus for emergency calling as defined in claim 7 wherein said means for activating said mobile phone dialer is further characterized in that said mobile phone dialer is responsive to a second predetermined key being operated for a time duration interval equal to or greater than a first predetermined time duration interval.

16. The apparatus for emergency calling as defined in claim 15 further characterized in that said second predetermined key is the END key.
